(19) United States
(12) Patent Application Publication
(10) Pub. No.: US 2023/0250906 A1
(43) Pub. Date: Aug. 10, 2023

(54) Configuration For Joining And Maintaining Aligned Engagement Between Sections Of Drainage Pipe

(71) Applicant: Dennis C. Hain, JR., Beaver Springs, PA (US)

(72) Inventor: Dennis C. Hain, JR., Beaver Springs, PA (US)

(21) Appl. No.: 18/106,549

(22) Filed: Feb. 7, 2023

Related U.S. Application Data
(60) Provisional application No. 63/308,693, filed on Feb. 10, 2022.

(51) Int. Cl. F16L 25/00

(52) U.S. Cl. CPC F16L 25/0063; F16L 25/0045; F16L 25/0054; F16L 11/15

(57) ABSTRACT

A reliable connection between the mating bell and spigot portions of adjoining pipe sections is proposed that utilizes a releasable interlocking configuration that maintains the connectivity between the two sections regardless of whether or not the gasket remains in position. Advantageously, the interlocking configuration requires only slight modifications to the bell and spigot portions of existing pipe, allowing for the configuration to be retro-fit onto existing pipe. One embodiment may utilize a set of locking (releasable) ties to join the pipe sections, and another embodiment may utilize a set of key members (releasable) that pass through aligned slots in the pipe sections.

### CROSS-REFERENCE TO RELATED APPLICATIONS

This application claims the priority benefit of U.S. Provisional Application 63/308,693 filed Feb. 10, 2022 and herein incorporated by reference.

### TECHNICAL FIELD

The present invention relates to the field of laying pipe sections (for example, drainage pipe) and, more particularly, to an apparatus to maintain releasable attachment between adjoining pipe sections in a manner that substantially reduces the possibility of mis-alignment between pipe sections.

### BACKGROUND OF THE INVENTION

Storm water management projects depend upon a reliable drainage system to quickly and easily remove excess water and accompanying debris. High density polyethylene (HDPE) drainage pipe is fast becoming the preferred choice for these projects, due to its light weight, ease of handling, and structural strength properties. Its versatility and cost efficiency make it more desirable than previous standard materials such as concrete or metal.

However, there is a significant chance that the connection between two joined sections of HDPE pipe may become loosened or moved apart to such a degree that the gap between the two sections may become out of tolerance. If such an out-of-tolerance gap is found during an inspection, remediation of the joint or replacement of the pipe will need to be instituted. These costly repairs can be a financial stress and burden, cutting into a contractor's profits, as well as perhaps creating an unstable support bed for the pipe.

### SUMMARY

The needs remaining in the prior art are addressed by the present invention, which relates to the field of laying pipe sections (for example, drainage pipe) and, more particularly, to an apparatus that maintains releasable attachment between adjoining pipe sections in a manner that substantially reduces the possibility of mis-alignment between pipe sections.

A reliable connection between the mating bell and spigot portions of adjoining pipe sections is proposed that utilizes a releasable interlocking configuration that maintains the connectivity between the two pipe sections regardless of whether or not the gasket remains in position. Advantageously, the interlocking configuration requires only slight modifications to the bell and spigot portions of existing pipe, allowing for the configuration to be retro-fit onto existing pipe. One embodiment may utilize a set of locking (releasable) ties to join the pipe sections, and another embodiment may utilize a set of key members (releasable) that pass through aligned slots in the pipe sections.

An example arrangement of the present invention may take the form of an apparatus for releasably interlocking a bell end termination of a first pipe section with a spigot end termination of a second pipe section. In this arrangement, the apparatus comprises a plurality of N engagement components disposed around the outer periphery of an end termination of either one of the first and second pipe sections, with each engagement component including a release mechanism. The apparatus also includes a plurality of N apertures disposed around the outer periphery of an end termination of the remaining pipe sections, wherein upon joining of the bell end termination with the spigot end termination the plurality of N engagement components align with the plurality of N apertures in a manner that interlocks the bell and spigot end terminations, and further wherein upon intended movement of the plurality of N release mechanisms, the bell and spigot end terminations may be released from each other.

One embodiment may have the plurality of N engagement components take the form of a plurality of N locking key members. In this case, each key member is configured to include an intermediate shaft portion, with a bar element disposed at a one termination of the shaft and a knob at the other. The bar member is positioned to be perpendicular to the shaft (forming an inverted “T”). The plurality of N apertures is this embodiment includes a first plurality of N slots disposed around the bell end termination of the first pipe section and a second plurality of N slots disposed around the spigot end termination of the second pipe section. The two pipe sections are arranged when joining such that the first plurality of N slots align with the second plurality of N slots. An aligned pair of slots is sized to accommodate a locking key member, with the bar element passing through the aligned pair and the intermediate shaft having a height H sufficient to allow for the knob element to rest upon the surface of the bell end termination of the first pipe section.

In another embodiment of the present invention, the plurality of N engagement components comprises a plurality of N locking ties, with a first end termination of each locking tie permanently attached in a defined position around the outer periphery around a pipe section and a second, opposing end termination comprising an enlarged tab element. Here, the plurality of N apertures comprises a plurality of apertures formed through a horizontal portion of a selected rib of the other pipe section such that a locking tie is configured to pass through the rib apertures, with the enlarged tab element resting against a portion of the joined arrangement adjacent to the selected rib to provide attachment of the first and second pipe sections.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is an isometric view of a typical pair of pipe sections that are to be laid end-to-end within a system, such as a drainage system;

FIG. 2 is a depiction of a first embodiment of the present invention, taking the form of a releasable tie interlocking system

FIG. 3 is an enlarged, sectioned view of the arrangement of FIG. 2, clearly showing the region where the pair of pipe sections are joined together;

FIG. 4 is an end view of an exemplary pipe section, in this case illustrating an example spaced-apart locations for placement of the individual releasable ties;

FIG. 5 is a depiction of a second embodiment of the present invention, taking the form of an interlocking key system that is used to releasably join together a pair of mating pipe sections;

FIG. 6 is a cut-away view of the embodiment of FIG. 5;

FIG. 7 is an enlarged view of a region of overlapped bell and spigot terminations of a pair of pipe sections, illustrating in particular the alignment between slots formed in both pipe sections;

FIG. 8 is a view similar to FIG. 7, in this case illustrating the insertion of an interlocking key through the pair of aligned slots;

FIG. 9 is another view of the arrangement of FIG. 8, where in this view the key has been rotated so as to interlock the pipe sections;

FIG. 10 illustrates an alternative embodiment of an example key that may be used in the second embodiment, in this case having a tapered bar portion for insertion into the aligned slots;

FIG. 11 shows yet another embodiment of an example key, in this case with a rounded bar portion, also considered to simplify the insertion process; and

FIG. 12 is an isometric rendering of the example key of FIG. 11.

### DETAILED DESCRIPTION

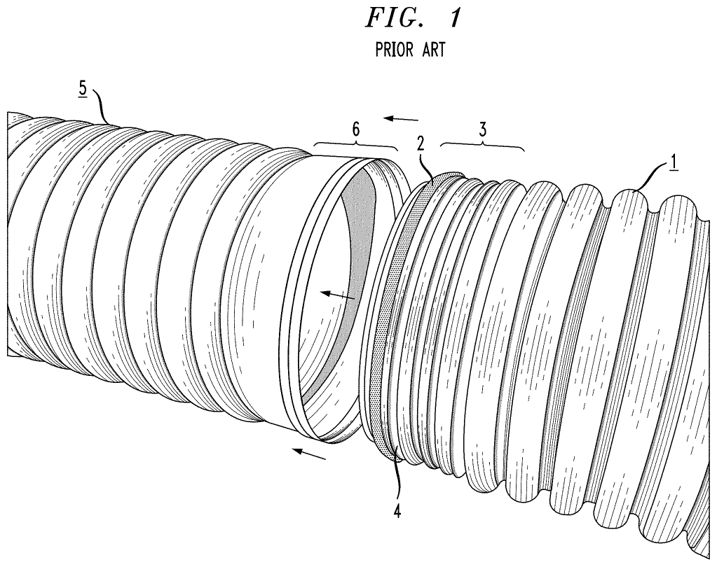

It has been found that a significant source of disturbed connections between sections of HDPE drainage pipes is that the rubber gasket installed on the spigot end of a pipe by the manufacturer is prone to roll out of its designated seat. FIG. 1 is an isometric view of a prior art arrangement, showing a first pipe section 1 having a rubber gasket 2 positioned on the spigot end 3 of the pipe section (gasket 2 typically positioned within a valley seat 4, as shown). A second pipe section 5 is shown as positioning its bell end 6 so as to capture spigot end 3 of first pipe section 1, where upon joining the two sections of pipe together, gasket 2 functions as a seal around the joining area. Any unwanted movement of gasket 2 out of its defined valley seat 4 will therefore impact the quality of the seal.

Additionally, it is possible that as two sections of pipe are being joined, the personnel will not join the mating spigot 3 and bell 6 together with a force sufficient to maintain their attachment. The lack of a complete mating between spigot 3 and bell 6 will eventually lead to storm water (or any other fluids) escaping the drainage system at this location and begin erosion of the bed under the pipe, which then leads to settling, depression, and maybe even holes in a roadway formed over the drainage pipe.

Thus, it is has been found that a more reliable connection between the mating bell and spigot portions of adjoining pipe sections may be created by using a releasable interlocking configuration, formed in accordance with the principles of the present invention, that maintains the connectivity between the two sections regardless of whether or not the gasket remains in position. Advantageously, the interlocking configuration requires only slight modifications to the bell and spigot portions of existing pipe, allowing for the configuration to be retro-fit onto existing pipe.

At least two different embodiments of the releasable interlocking configuration are considered as best modes of carrying out the invention at a time contemporaneous with the filing of this application. It is presumed, however, that over time various other specific configurations of a releasable interlocking mechanism may occur to those skilled in the art. These other, specific configurations are considered to fall within the spirit and scope of the parameters of the present invention as described in detail below.

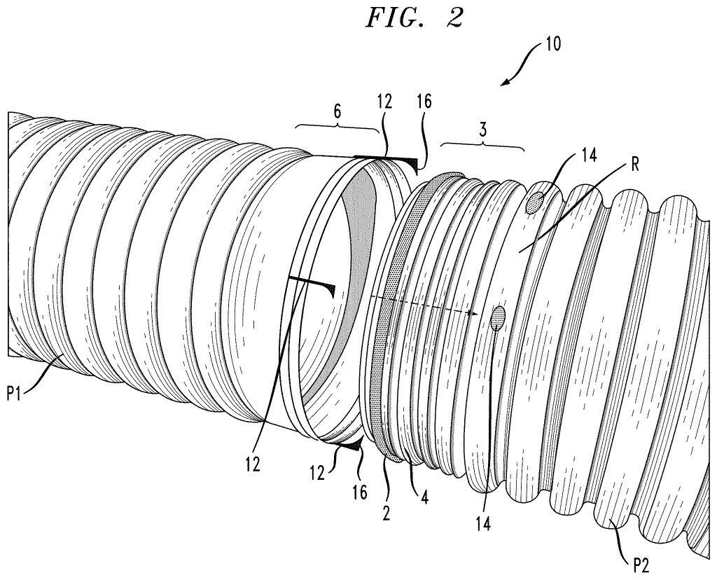

FIG. 2 illustrates a first embodiment of the present invention, which comprises a releasable tie interlocking system 10. In particular, interlocking system is shown as comprising one or more tie attachments 12 that is/are permanently connected to a first end (for example, bell end 6) of a pipe section P1. Mating apertures 14 are formed around a designated rib R of an opposing end (for example, spigot end 3) of an adjoining pipe section and are positioned around the periphery of rib R so to be in alignment with tie attachments 12.

In accordance with the principles of the present invention, and particularly the interlocking system embodiment 10, when installing the pipe sections, a mating pipe section P2 is oriented with pipe section P1 so that a tie attachment 12 from pipe section P1 passes through a mating aperture 14 in pipe section P2. Tie attachment 12 may take on a variety of forms of various latching configurations well-known in the art. Apertures 14 may comprise any suitable type of attachment coupling/connection linkage that will mate with tie attachments 12 in a releasable manner.

In preferred arrangements of this embodiment of the present invention, a multiple number of tie attachments 12 are formed around the termination of bell end 6. For example, a pair of tie attachments may be positioned 180° apart, or a set of four tie attachments may be positioned 90° apart. As long as spigot portion 3 is formed to include a sufficient number of apertures around rib R, interlocking between pipe sections P1 and P2 will take place. It is to be understood that in certain installations the location of an aperture 14 at the “bottom” of pipe section (the “bottom” defined as a pipe section is positioned in place within a prepared trench) may be problematic, particularly in terms of later accessibility should the need arise to repair or replace a damaged section of pipe.

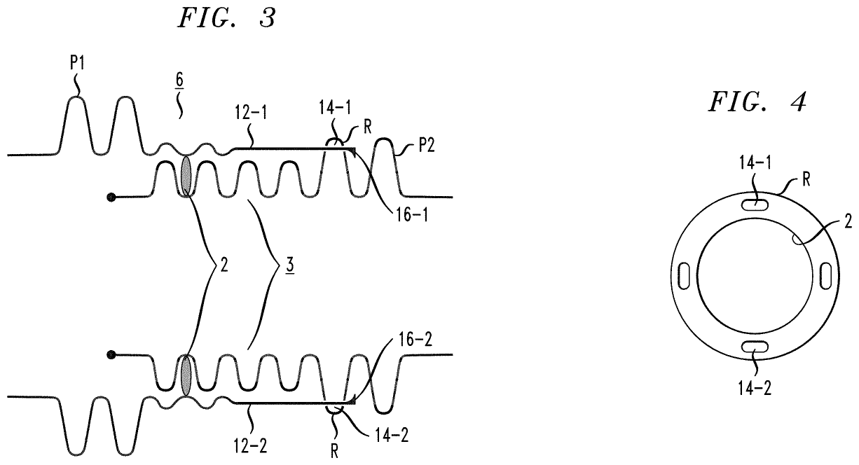

FIG. 3 is an enlarged view showing the interlocking engagement between pipe sections P1 and P2. As clearly shown in this view, gasket 2 remains firmly in place as a sealing interface between spigot end 3 of pipe section P2 and bell end 6 of pipe section P1. Here, a pair of tie attachments 12-1 and 12-2 is shown as interlocked with a pair of mating apertures 14-1 and 14-2. FIG. 4 is end view of an exemplary spigot end 3, showing a placement of mating apertures 14 around a designated rib R.

In accordance with this embodiment of the present invention, tie attachments 12 are shown as including tab terminations 16 that are sized and configured to pass through mating apertures 14 during the pipe section joining process, and then rest is place along an outer portion of designated rib R. The action of tab terminations 16 with mating apertures 14 is similar to the standard “locking” function of a zip tie. Tab terminations 16 are shown as pointing inward toward the interior of the pipe sections, where this orientation ensures that tab terminations 16 remain latched in place once the installed pipe sections are installed and covered with dirt, stone, and other covering material.

In accordance with the principles of this embodiment of the present invention, once tie attachments 12 are passed through mating apertures 14 and locked in place, the pipe sections will be held together in a stable arrangement that prevents the creation of large gaps between the mating bell and spigot ends. The resulting structure will be soil and water tight, since it is essentially impossible for gaps to form between the locked-together pipe sections. Should the need arise to remove a pipe section, one can simply move tab terminations 16 to align with mating apertures 14 (since tie attachments 12 are formed to exhibit a lever arm movement capability). The intentional movement of tabs 16 releases tie attachments 12 from mating apertures 14, allowing one or both sections of pipe to be removed and replaced, this embodying the desired “releasable” characteristic of the present invention.

Indeed, it is an aspect of the present invention that the interlocking configuration is both reliable (i.e., ensuring a “positive”, locked attachment each time) and releasable (i.e., by virtue of tabs 16). The reliability significantly reduces the chance that mating pipe sections may become dislodged to the point of forming an out-of-tolerance gap; the ability for personnel to “release” the connection allows for flexibility in controlling the installation process.

While the embodiment described above particularly illustrates an arrangement of interlocking configuration 10 where tie attachment 12 is formed on the bell end of a pipe section and aperture 14 is formed on the spigot end, the opposite arrangement is obviously possible as well, with the tie attachment formed on the spigot and the aperture on the bell. Alternatively, a “retrofit” version of this embodiment of the present invention may take the form of a collar interface that may be positioned between opposing bell and spigot ends of conventional pipe sections, providing the same releasable attachment configuration.

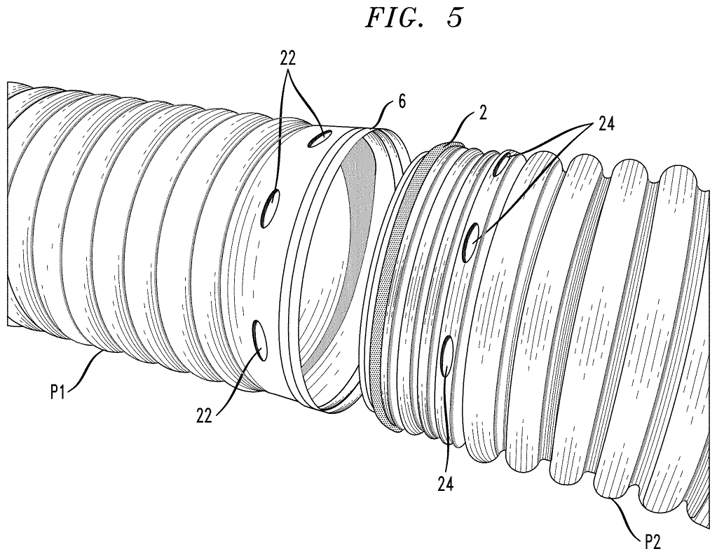

FIGS. 5-12 illustrate an alternative, compact releasable, interlocking system 20 that may also be used to maintain pipe sections in an aligned configuration in accordance with the principles of the present invention, providing the same advantages of reliable and releasable, as discussed above.

FIG. 5 is an isometric view of pipe sections P1 and P2, where in accordance with this embodiment of the present invention, a first plurality of N slots 22 formed around the periphery of bell termination 6, with a like plurality of N slots 24 formed around an end portion of spigot termination 3 of mating pipe sections P1 and P2. In accordance with this embodiment of the present invention, slots 22 and slots 24 are similar in size and location such that as the two pipe sections are joined, one pipe section may be rotated with respect to the other until their respective slots are aligned. A cut-away view of joined pipe sections P1 and P2 is shown in FIG. 6 which clearly illustrates an alignment between slot 22-1 (on the bell portion of P1) and slot 24-1 (on the spigot portion of P2). A similar pairing of slots 22-2 and 24-2 is also shown in FIG. 6. A top view of a slot 22-i is also shown in FIG. 6, and is included in this diagram to illustrate an exemplary length L and width W of slots 22, 24 (for discussion purposes only and not to scale).

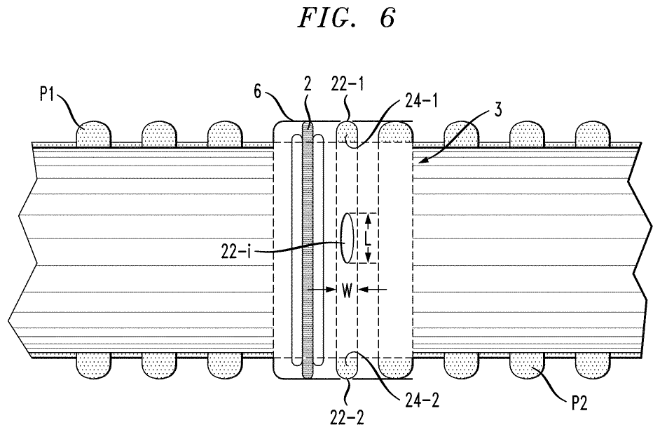

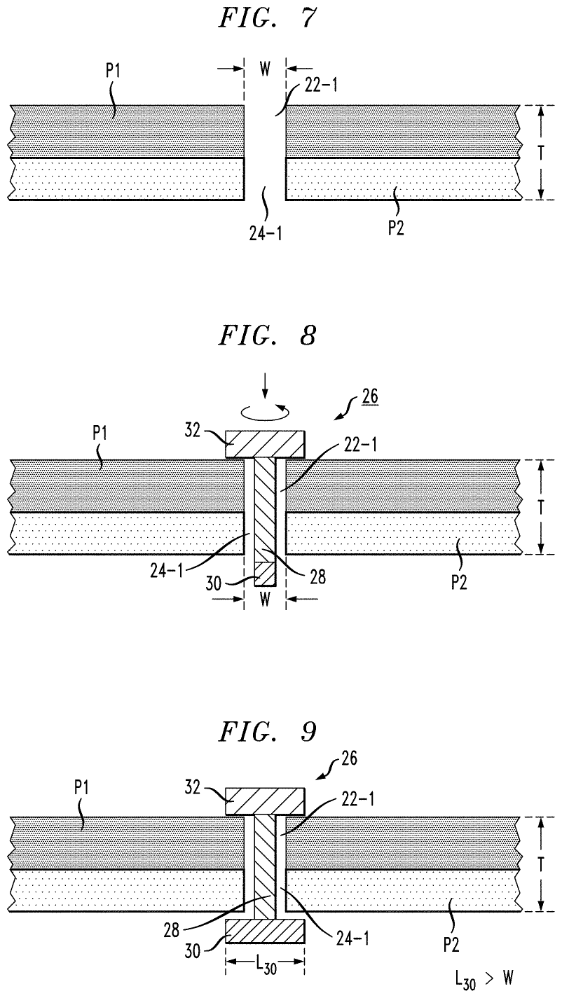

FIG. 7 is an exemplary diagram showing a bell slot 22-1 and a spigot slot 24-2 in a cut-away, aligned view. The combined thickness T of the drain pipe walls in this joined region, as well as the width W of the aligned slots, are important design parameters of releasable, interlocking system 20, particularly with respect to the design of a locking key component that will hold the pipes together at this joined area in a locked, but releasable, fashion. The relationship between the dimensions of slots 22, 24 and the locking key component will become evident with reference to the following FIGS. 8 and 9.

One slots 22, 24 are aligned a releasable locking key component 26 may be positioned through each aligned pair. FIG. 8 illustrates aligned slot pair 22-1, 24-1, as well as a releasable locking key component 26 that is used to maintain alignment between the slots and, therefore, joining of pipe sections P1 and P2. Releasable locking key component 26 may take a variety of forms, some of which will be described below. In the exemplary embodiment as shown in FIG. 8, key component 26 includes an intermediate shaft element 28 that is only slightly longer that the thickness T of the overlapped pipe sections. A lower termination of key component 26 takes the form of a horizontal bar 30 that forms a “T” with shaft element 28. A knob 32 is disposed at the opposing end of shaft element 28, and is designed to rest against the outer surface of pipe P1. In this manner and as shown in FIG. 8, when positioned over the aligned slot pair 22-1, 24-1, horizontal bar 30 is able to pass through the aligned pair. Once through, knob 32 is turned such that horizontal bar 30 is positioned perpendicular to the aligned slot pair, as shown in FIG. 9. In accordance with this embodiment of the present invention, horizontal bar 30 is formed to have a length L₃₀ that is greater than the width W of joined slots 22, 24, thus ensuring that key component 26 cannot become dislodged and fall out of place when the pipe sections are interlocked. While the views of FIGS. 7-9 only illustrate a single point of joining between pipe sections P1 and P2, a plurality of such interlocking configurations are disposed around the circumference of the joined pipe sections (e.g., separated by 90°, for example, as shown in FIG. 4).

As evident in the views of both FIGS. 8 and 9, shaft 28 is configured to be only slightly longer that the combined thickness of the overlapped pipe walls, thus ensuring a securing joining between the two pipe sections. While secure, it is clear that should a need arise to separate the two pipe sections, knob 32 may be rotated back into the position as shown in FIG. 8, allowing for bar 30 to pass upward and away from the aligned slots 22, 24.

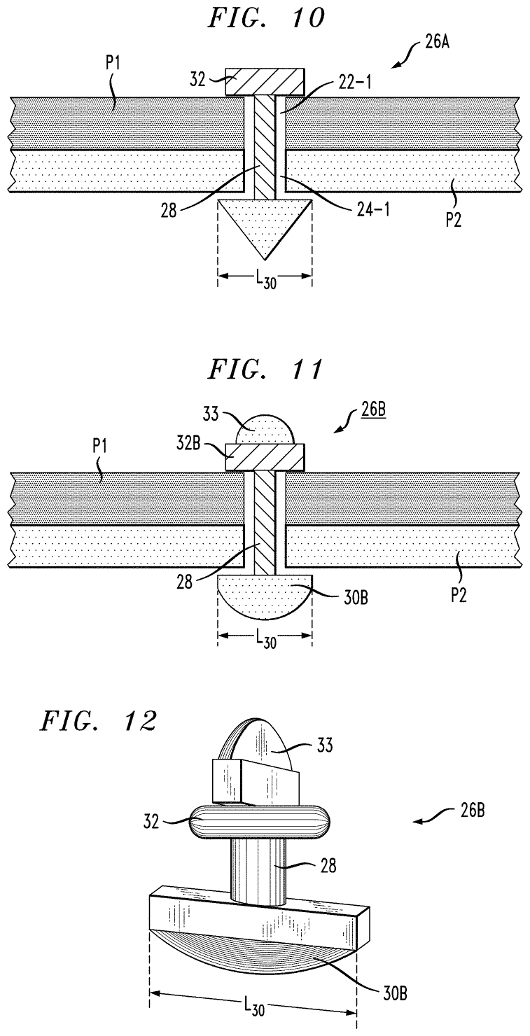

It is to be understood that key component 26 may take on a variety of different shapes. FIG. 10 illustrates another example key component, referred to as key component 26A. Here, a horizontal bar 30A is shown to have a tapered form 31 that has been found to easily pass through the joined slot pair 22-1, 24-1, yet still exhibit a length L₃₀ across its top region that is greater than the width of the aligned slots and therefore provides a secure interlocking when rotated. FIG. 11 shows yet another formation of key component 26, where in this case a horizontal bar 30B is formed to have a rounded lower portion, further easing the ability to pass the bar through the paired slots. Knob 32B in this example of FIG. 11 includes an upper protrusion 33 that acts as a grip member for easier manipulation by the user. FIG. 12 is an isometric rendering of key component 26 as shown in FIG. 11, clearly illustrating bar 30B, shaft 28 and knob 32B (including upper protrusion 33).

Various other types of interlocking key components may be used, at least comprising a shaft that is slightly longer than the thickness of the joined pipe sections with rotatable stopper bar to releasably join the pipe sections together.

It will be appreciated by those skilled in the art that changes may be made to the above-described embodiments without departing from the broad inventive concepts as defined by the following claims. It is understood, therefore, that this invention is not limited to the particular disclosed embodiments, but it is intended to cover modifications within the spirit and scope of the disclosure. Moreover, aspects and features of various embodiments may be combined in a particular device; and fewer than all aspects and features of a particular embodiment disclosed herein may be sufficient for a functional embodiment.

What is claimed is:

1. An apparatus for releasably interlocking a bell end termination of a first pipe section with a spigot end termination of a second pipe section, the apparatus comprising
a plurality of N engagement components disposed around the outer periphery of an end termination of either one of the first and second pipe sections, each engagement component including a release mechanism; and
a plurality of N apertures disposed around the outer periphery of an end termination of the remaining one of the first and second pipe sections, wherein upon joining of the bell end termination with the spigot end termination the plurality of N engagement components align with the plurality of N apertures in a manner that interlocks the bell and spigot end terminations, and further wherein upon intended movement of the plurality of N release mechanisms, the bell and spigot end terminations are released from each other.

2. The apparatus as defined in claim 1, wherein
the plurality of N engagement components comprises a plurality of N locking key members, each key member having
an intermediate shaft portion,
a bar element disposed at a first end termination of the intermediate shaft portion and positioned to be perpendicular thereto, and
a knob element disposed at a second, opposing end termination of the intermediate shaft portion; and
the plurality of N apertures comprises a first plurality of N slots disposed around the bell end termination of the first pipe section and a second plurality of N slots disposed around the spigot end termination of the second pipe section, wherein upon joining of the first and second pipe sections, the first plurality of N slots may be aligned with the second plurality of N slots, an aligned pair of slots sized to accommodate a locking key member, with the bar element passing through the aligned pair and the intermediate shaft having a height H sufficient to allow for the knob element to rest upon the surface of the bell end termination of the first pipe section.

3. The apparatus as defined in claim 2, wherein the overlapped regions of the first and second pipe sections at the location of each aligned pair of slots has a thickness T which is only slightly less that the height H of the intermediate shaft of the knob element, and the length of the horizontal bar element is greater than the width W of the aligned pair of slots.

4. The apparatus as defined in claim 2, wherein the rotation of the knob element of the locking key member moves the associated bar member between a locked position, joining together the bell and spigot end terminations, and an unlocked position, releasing the attachment between the bell and spigot end terminations such that the first pipe section may be separated from the second pipe section.

5. The apparatus as defined in claim 2 wherein the horizontal bar element of at least one locking key member comprises a rectangular element.

6. The apparatus as defined in claim 2 wherein the horizontal bar element of at least one locking key member comprises a tapered, triangular element with the apex of the taper positioned toward the center of the joined pipe sections.

7. The apparatus as defined in claim 2 wherein the horizontal bar element of at least one locking key member comprises a rounded lower region, allowing for efficient passage through the aligned pair of slots.

8. The apparatus as defined in claim 2 wherein the knob element includes an upper protrusion, forming a grip member to facilitate the rotation of the knob element.

9. The apparatus as defined in claim 1, wherein
the plurality of N engagement components comprises a plurality of N locking ties, with a first end termination of each locking tie permanently attached to its defined position around the outer periphery and a second, opposing end termination comprising an enlarged tab element; and
the plurality of N apertures comprises a plurality of apertures formed through a horizontal portion of a selected rib such that a joining locking tie is configured to pass through the rib apertures, with the enlarged tab element resting against a portion of the joined arrangement adjacent to the selected rib to provide attachment of the first and second pipe sections.

10. The apparatus as defined in claim 9, wherein the plurality of locking ties exhibit a cantilever movement sufficient to allow for the enlarged tab elements to moved vertically and pass out of the horizontal rib tabs, releasing the first pipe section from the second pipe section.
